(19) United States
(12) Patent Application Publication
(10) Pub. No.: US 2011/0210109 A1
(43) Pub. Date: Sep. 1, 2011

(54) Laser Processing Nozzles and Methods

(75) Inventors: Arnd Szelagowski, Kirchheim unter Teck (DE); Florian Sepp, Altenstadt (DE); Volker Metsch, Ingersheim (DE)

(73) Assignee: TRUMPF WERKZEUGMASCHINEN GMBH + CO. KG, Ditzingen (DE)

(21) Appl. No.: 13/095,142

(22) Filed: Apr. 27, 2011

Related U.S. Application Data
(63) Continuation of application No. PCT/EP2009/006493, filed on Sep. 8, 2009.

(30) Foreign Application Priority Data
Oct. 29, 2008 (DE) 102008053729.2

(51) Int. Cl. B23K 26/00

(52) U.S. Cl. 219/121.72; 219/121.67

(57) ABSTRACT

The invention relates to a laser processing nozzle for processing metal sheets. The processing nozzle includes a supply chamber for a processing gas and a laser beam and a mouth region which directly adjoins the supply chamber along the longitudinal axis of the nozzle. The mouth region is narrowed relative to the supply chamber and forms a minimum diameter of the laser processing nozzle. A step is formed between the supply chamber and the mouth region for swirling the processing gas, and an opening region which widens relative to the mouth region adjoins the mouth region along the longitudinal axis of the nozzle.

### CROSS-REFERENCE TO RELATED APPLICATIONS

This application is a continuation of, and claims priority under 35 U.S.C. §120 to, PCT/EP2009/006493, filed on Sep. 8, 2009, and designating the U.S., which claims priority under 35 U.S.C. §119 to German Patent Application No. 10 2008 053 729.2, filed on Oct. 29, 2008. The contents of the prior applications are hereby incorporated by reference in their entirety.

### TECHNICAL FIELD

The present invention relates to laser processing machines, to laser processing nozzles for processing metal sheets and to methods of laser processing metal sheets.

### BACKGROUND

During laser processing of workpieces, in particular laser cutting of metal sheets, a processing gas or a cutting gas can be supplied to a processing location by a laser processing nozzle. In such laser processing, the cutting gas can facilitate the cutting operation by forming a pressure cushion above the processing location which causes the molten mass and slag produced during the cutting operation to be discharged out of the cutting seam during cutting.

Generally, laser processing nozzles that are used have a supply chamber with a conical inner contour for the laser beam and a processing gas. In such nozzles, the conical inner contour of the supply chamber merges into a cylindrical mouth region such that the diameter of the mouth region corresponds to the diameter of the inner contour of the supply chamber at the side facing the mouth region. Different nozzle diameters can be used for different sheet metal thicknesses. Typically, a larger nozzle diameter is used when processing thicker metal sheets. Generally, using a greater nozzle diameter provides a higher mass flow which can be necessary to process thick metal sheets because more material has to be discharged from the cutting seam.

If the material is simply melted and not burnt (so-called “melt cutting”) during the processing operation, the gas pressure in the pressure chamber of the cutting head must typically have a minimum level of pressure so that the pressure cushion's pressure at the processing location is high enough to reliably discharge the molten mass. In the case of large nozzle diameters, gas pressures greater than 15 bar (e.g., ranging from 15-25 bar) can be required.

In addition to the above-described standard nozzle, a large number of nozzles are known for special purposes. For example, De Laval nozzles for laser-supported thermal cutting or nozzles for cutting silicon blocks which have a conical opening region at the side facing the workpiece as described in U.S. Pat. No. 6,423,928.

WO 2007/059787 discloses a nozzle having an inner cone as a supply region, a cylindrical mouth region, and a cavity which adjoins the mouth region that is directed towards the workpiece and has an edge for producing a swirling flow. The nozzle described therein is typically suitable for cutting steel sheets (e.g., high-grade steel sheets) having a thickness greater than 8 mm. During operation, a pressure cushion is produced in the cavity which stabilizes the central cutting gas beam. Consequently, this results in the cutting gas beam better adjoining the melt front and the molten mass of the workpiece, thereby the molten mass being discharged more continuously. The improved molten mass discharge characteristics can become apparent by observing a substantially reduced roughness of the cutting edges.

However, it has been found that the advantages of that nozzle can be typically only utilized if the laser processing is conducted with a small distance between the nozzle and the metal sheet (e.g., at distances between 0.3 mm-0.5 mm). If the distance between the nozzle and the metal sheet becomes too large, the pressure cushion can become too small to obtain the desired gas dynamics effect and the molten mass cannot be discharged.

The metal laser processing nozzle is generally electrically insulated from the remainder of the laser processing machine and from the workpiece which is typically a metal sheet. Typically, the metal laser processing nozzle is fixed to the laser processing machine by a dielectric material (e.g., a ceramic material). The capacitance of the system (e.g., capacitance between the laser processing nozzle and the metal sheet workpiece) can be measured using a sensor of a distance control to determine the distance between the laser processing nozzle and the metal sheet workpiece. Capacitance between two objects generally has an inverse relationship to the distance between the two objects. Thus, during measurement, an increase in the capacitance measured between the laser processing nozzle and the metal sheet workpiece can indicate that the distance between the two components has decreased proportionally. However, at small distances (e.g., less than 0.4 mm), the known distance control method discussed above tends to perform inaccurately with the known laser processing nozzles. In some cases, the sensor of the distance control has been shown to produce incorrect distance measurement values, falsely providing readings that indicate a collision between the laser processing nozzle and the workpiece. In addition, the distance measurements at the small distances (e.g., less than 0.4 mm) can be influenced more sensitively than distance measurements at larger distances (e.g., more than 1.0 mm). For example, if a slight disruption of the electromagnetic field (e.g., related to gas plasma) occurs, an immediate change in the distance measurements can result. As a result, the fluid dynamics of the gases used in the process can be substantially disrupted, the discharge of molten mass can deteriorate, and an interruption of the cut or a collision report may result. Therefore, a low level of susceptibility to disruption of the laser processing nozzle is desired in the short ranges (e.g., less than 0.4 mm).

### SUMMARY

In one aspect of the invention a laser processing nozzle includes a step which is formed between a supply chamber and a mouth region for swirling the processing gas, and an opening region which adjoins the mouth region along the nozzle longitudinal axis and which widens relative to the mouth region for the discharge of the processing gas.

In some embodiments, the step between the supply chamber and the mouth region of the laser processing nozzle produces occurrences of turbulence within the nozzle. These occurrences of turbulence can act as pressure cushions and can attenuate small changes in pressure that occur when the nozzle distance (i.e., the distance between the nozzle and the workpiece) changes. In such embodiments, the laser processing nozzle for processing metal sheets can typically be used in an operationally reliable manner with small distances between the laser processing nozzle and the metal sheet (e.g., less than 0.8 mm or 0.5 mm). In this instance, the supply chamber, the mouth region, and the opening region are typically arranged so as to be radially symmetrical and coaxial relative to the nozzle longitudinal axis.

In some embodiments, the step between the supply chamber and the mouth region can extend along a plane that is perpendicular to the nozzle longitudinal axis. However, in other embodiments, it is also possible for the step to extend along a plane that is not perpendicular (e.g., between 80° and 100°) to the longitudinal axis.

In some embodiments, the step can be a planar face (e.g., a flat surface). However, in other embodiments, the step can alternatively be a non-planar face (e.g., the face may have curvature). In some cases, the outer edge of the step can merge into the outer surface of the supply chamber at a rounded corner. A significant aspect of the laser processing nozzle is that a discontinuity in the inner contour of the laser processing nozzle is produced by the step and causes turbulence in the processing gas.

In some embodiments, the cross-sectional surface area of the step is at least four times as large as the cross-sectional surface area of the mouth region. The cross-sectional surface area of the step is defined in this case as the surface area which the step covers (including the mouth region) in a plane perpendicular to the nozzle longitudinal axis. Experiments have shown that the cross-sectional area of the step should be relatively large in comparison with the cross-sectional area of the mouth region. In some embodiments, the cross-sectional area of the step is more than four times as large or in some cases more than eight times as large as the cross-sectional area of the mouth region. If a nozzle has radially symmetrical inner contours (e.g., when the supply chamber defining the outer edge of the step and the mouth region are substantially concentric cylinders), the outer diameter of the step should typically be at least twice as large as the diameter of the cylindrical mouth region and generally not be greater than four times that diameter.

In some embodiments, a first non-cylindrical (e.g., conical) portion of the opening region directly adjoining the mouth region has a first opening angle that is between 20° and 80° (e.g., between 25° and 35°). Experiments have shown that in the portion of the opening region directly adjoining the mouth region, the nozzle contour should open at an angle greater than the angle used in De Laval nozzles having comparable dimensions. However, the opening angle in such nozzles is typically no more than 10°. In such embodiments, the laser processing nozzle can be produced particularly simply if the nozzle contour has at least one conical portion.

In some embodiments, a second non-cylindrical (e.g., conical), portion adjoins the first portion and has a second, larger opening angle which is between 100° and 160° (e.g., between 135° and 145°). The flow relationships desired at the processing side can be reproduced as a close approximation by two such non-cylindrical portions, which are in some cases conical.

In some embodiments, more than two conical portions, whose opening angles become increasingly large as the distance from the mouth region increases, can also be formed in the opening region. In such embodiments, the opening angles can increase from portion to portion more gradually than in nozzles having only two conical portions in the opening region.

It has been found advantageous to form a rounded portion between the first portion and the second portion and any other portions in order to obtain a continuous transition between the portions and thereby to counteract the formation of turbulence in the gas flow being discharged. However, in some cases, a cylindrical region which has a small length in the nozzle longitudinal direction and in which the last conical portion may not merge in a continuous manner (i.e., without a rounded edge) can adjoin the conical regions in the region of the discharge opening of the laser processing nozzle.

In some embodiments, the opening angle of the inner contour of the opening region increases continuously as the distance from the mouth region increases. As described above, the increase of the opening angle may occur along two or more conical portions. If the number of conical portions is very large, a predetermined function for the radius of the inner contour of the opening region can be approximated based on the conical portions. In some cases, the radius of the inner contour may also be adapted directly to a preferably continuous mathematical function which increases smoothly.

In some embodiments, the diameter of the discharge opening of the laser processing nozzle formed at the opening region is at least twice as large as the length of the opening region along the nozzle longitudinal axis. The selection of a discharge opening with a relatively large diameter in comparison with the length of the opening region was found in experiments to be particularly advantageous for the discharge of the processing gas.

In some embodiments, the supply chamber and the mouth region are arranged coaxially relative to the nozzle longitudinal axis and are, in some cases, constructed to be cylindrical. If both the supply chamber and the mouth region are cylindrical, the step forms the base face of the cylindrical supply chamber, which the outer surface of the cylindrical mouth region adjoins. However, the mouth region is typically cylindrical, whereas the supply chamber may be constructed to be cylindrical or of another form (e.g., rectangular or square).

In some embodiments, the step formed on the supply chamber may not extend perpendicularly to the nozzle axis but instead may be a conical face. In such cases, the angle between the longitudinal axis of the nozzle and the conical step face can be between approximately 80° and 100°. A curved step is also possible if it is ensured that occurrences of turbulence in the processing gas are produced at the step.

Other advantages of the invention will be appreciated from the description and the drawings. The above-mentioned features and those set out below can also be used individually or together in any combination. The embodiments shown and described are not intended to be understood to be a conclusive listing, but instead are of exemplary character for describing the invention.

### DESCRIPTION OF DRAWINGS

FIG. 1 is a perspective view of a laser cutting machine.

FIG. 2a is a cross-sectional schematic illustration of a laser processing head having a lens.

FIG. 2b is a cross-sectional schematic illustration of a laser processing head having two mirrors.

FIG. 3 is a cross-sectional view of a laser processing nozzle including an opening region having a single conical portion.

FIG. 4 is a cross-sectional view of a laser processing nozzle including an opening region having two conical portions.

FIG. 5 is a cross-sectional view of a laser processing nozzle including an opening region having a rounded portion between two conical portions.

FIG. 6 is a cross-sectional view of a laser processing nozzle including an opening region having a continuously increasing opening angle.

### DETAILED DESCRIPTION

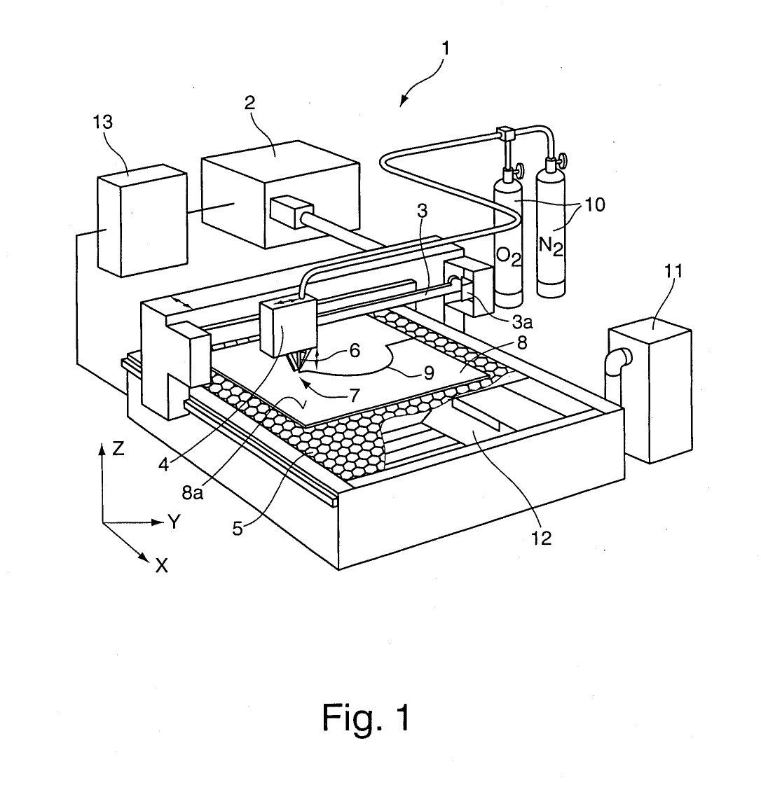

FIG. 1 shows a laser cutting machine 1 having a laser resonator 2, a laser processing head 4, and a workpiece support 5. It is possible to use, as the laser resonator 2, a CO₂ laser or a solid state laser, (e.g., a disc, diode or fiber laser), depending on the required power characteristics of a laser beam 6 produced by the laser resonator 2, with regard to wavelength, maximum beam quality, etc.

The laser beam 6 produced by the laser resonator 2 is guided via a beam guide 3, (e.g., by a redirecting mirror 3a) and shaped in accordance with the processing task. The beam guide 3 is typically completely shielded during operation of the laser cutting machine 1, for safety reasons and in order to prevent contamination.

The closure of the beam guide 3 is formed by the laser processing head 4, in which the laser beam 6 is focused on a processing location 7 and is orientated perpendicularly relative to the surface 8a of a workpiece 8, in order to melt the material of the workpiece 8. In some cases, the workpiece 8 can be a high-grade steel sheet having a thickness greater than 8 mm.

During laser processing, the workpiece 8 is cut with the laser beam 6, that is, the workpiece 8 is melted or oxidized in a point-like manner at a location and the molten mass produced at the location is discharged, leaving a hole in the workpiece 8. The laser beam 6 is subsequently moved relative to the workpiece 8 so that a continuous cutting aperture 9 is produced, along which the laser beam 6 separates the workpiece 8.

Both the piercing and the laser cutting can be facilitated by using a processing gas added in the laser cutting head 4. Processing gases (or cutting gases) 10 which may be used include oxygen, nitrogen, compressed air and/or other application-specific gases which facilitate the cutting operation by forming a pressure cushion above the processing zone to discharge the molten mass from the cutting seam. Additionally, the cutting gas 10 can improve the chemistry of the laser cutting by supporting combustion. Selection of the cutting gas used can depend on the materials to be cut and the cutting quality requirements of the workpiece. Particles and gases produced during cutting can be discharged from a discharge chamber 12 by a discharge device 11. A central control unit 13 serves to automatically control the processing operations of the laser cutting machine 1. In some cases, the central control unit 13 is configured to automatically position the laser cutting head 4 at the processing location 7 and to adjust the beam parameters of the laser beam 6 (e.g., laser power) and the processing parameters at the machine (e.g., gas type, gas pressure, nozzle distance, etc.).

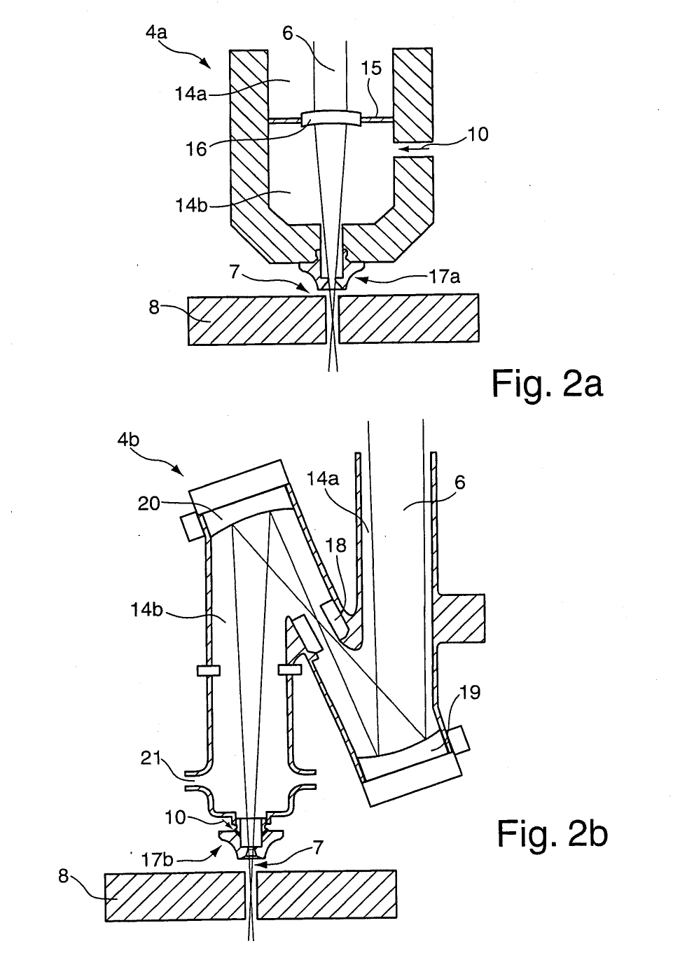

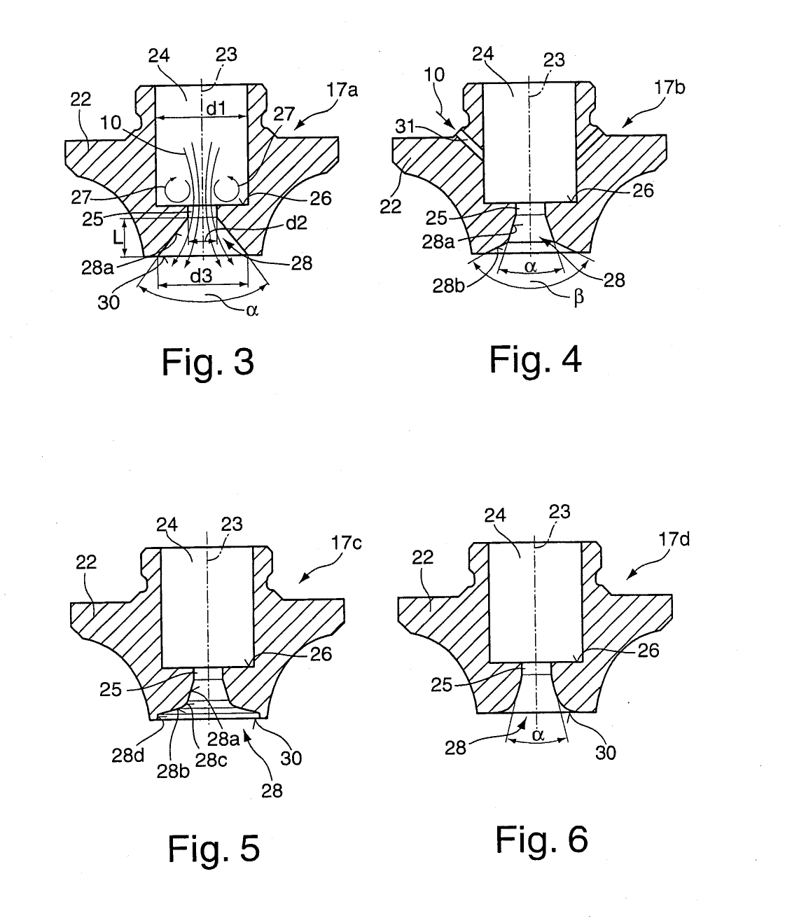

FIG. 2a shows one configuration of the laser cutting head 4 of FIG. 1 in the form of a lens cutting head 4a. The lens cutting head 4a has a housing region 14a which is associated with the beam guide 3 and a housing region 14b which is associated with the laser processing operation, where the regions are separated from each other in a gas-tight manner by an intermediate wall 15. A focusing lens 16 is integrated in the intermediate wall 15. The housing region 14a which is associated with the beam guide is flushed with clean gas and thereby protected from particles of dirt from the environment (e.g., cutting fumes) and other undesirable gaseous impurities. However, the housing region 14b which is associated with the laser processing operation is filled with the processing gas 10, typically nitrogen or oxygen in order to support the processing mechanically and optionally chemically. In the housing region 14b a fluid pressure of the cutting gas 10 contained therein of several bar is typically present during processing. The laser beam 6 and the cutting gas 10 are guided to the workpiece 8 by a laser processing nozzle 17a which will be described below in greater detail with reference to FIG. 3.

FIG. 2b shows another configuration of the laser cutting head 4 of FIG. 1 in the form of a mirror cutting head 4b. It also has a first housing portion 14a which is associated with the beam guide 3 and which is separated by an aperture 18 from a second housing portion 14b associated with the laser processing operation. An intermediate focus is formed in the region of the aperture 18 by a focusing paraboloid mirror 19 in the first housing portion 14a. An ellipsoid mirror 20 arranged in the second housing portion 14b focuses the laser beam 6 on a focal point at the processing location 7 on the workpiece 8.

The first housing portion 14a is flushed with a clean gas at a slight excess pressure; the second housing portion 14b does not have any gas flushing. In order to be able to laser-cut with the mirror cutting head 4b, a pressure increase of the cutting gas 10 is generated by an annular gap nozzle 17b which is illustrated in detail in FIG. 4 and whose construction is described in greater detail below. Since such nozzles can have a backflow, proper outflow is typically ensured by providing sufficiently large openings 21 between the aperture 18 and the annular gap nozzle 17b. In order to prevent reversal of the direction of the leakage flow into the beam guide 3, the openings 21 are typically large enough such that a static pressure greater than the pressure in the beam guide 3 will not accumulate in the second housing portion 14b.

Both the laser processing nozzle 17a of the lens cutting head 4a and the laser processing nozzle 17b of the mirror cutting head 4b are typically electrically insulated relative to the laser processing machine 1 and the workpiece 8. Such insulation can be achieved by using a dielectric in the form of a ceramic material. As discussed above, the capacitance of the system (e.g., capacitance between the laser processing nozzle and the metal sheet workpiece) can be determined based on a distance between the processing nozzle and the workpiece, as measured by a sensor of a distance control (not shown). The laser cutting machine 1 is generally able to obtain a precise distance measurement during a laser cutting operation. Laser processing nozzles 17a-d which are also suitable for laser cutting the workpiece 8 in an operationally reliable manner with relatively short distances (e.g., less than 0.8 mm) between the laser processing nozzle and the workpiece are described below with reference to FIGS. 3 to 6.

FIG. 3 shows the laser processing nozzle 17a for the lens cutting head 4a of FIG. 2a. The laser cutting nozzle 17a has a nozzle body 22 which is substantially rotationally symmetrical relative to a nozzle longitudinal axis 23 and which first has, along the nozzle longitudinal axis 23, a cylindrical supply chamber 24 for the laser beam and for the processing gas 10, which a cylindrical mouth region 25 adjoins. The cylindrical supply chamber 24 and the mouth region 25 are arranged coaxially relative to the nozzle longitudinal axis 23. The cylindrical supply chamber 24 has a diameter d1 of approximately 8 mm and the cylindrical mouth region 25 has a diameter d2 of approximately 2.8 mm. At the transition between the supply chamber 24 and the mouth region 25, a step 26 is formed. The step 26 has a cross-sectional area (including the cross-sectional area of the mouth region 25) (¼π(d1)²) that can be more than approximately four times as large as the cross-sectional area of the mouth region 25 (¼π(d2)²). The step 26 serves to swirl the processing gas 10, producing turbulence in the supply chamber 24 at the step 26 adjacent to the laminar flow region, shown in FIG. 3 as vortices 27. The vortices 27 act as pressure cushions and can attenuate small changes in pressure that may occur when the distance of the laser processing nozzle 17a from the workpiece 8 changes.

At the side facing away from the supply chamber 24, the cylindrical mouth region 25 is adjoined along the nozzle longitudinal axis 23 by an opening region 28 which widens radially relative to the mouth region and which comprises a single conical portion 28a having an opening angle α of approximately 75°. At the side of the opening region 28 opposite the mouth region 25, there is formed a discharge opening 30 of the laser processing nozzle 17a whose diameter d3 substantially corresponds to the diameter of the cylindrical supply chamber 24. The length L of the opening region 28 is approximately 3 mm. In some cases, the diameter d3 of the discharge opening 30 which can be approximately 8 mm is more than twice as large as the length L. The radially widening inner contour 28a of the opening region 28 defines a flow profile to produce flow relationships at the processing location known to be advantageous.

FIG. 4 shows a laser processing nozzle 17b which differs from the laser processing nozzle 17a shown in FIG. 3 in that the opening region 28 has two conical portions 28a, 28b, of which the first portion 28a has a first opening angle α of approximately 30° and the second portion 28b adjoining the first has an opening angle β which is greater than the first opening angle α and which can be approximately 140°. Using the two portions 28a, 28b, it is possible to obtain the desired flow relationships at the processing location 7 as a close approximation. The laser processing nozzle 17b further has an annular gap 31 which serves to supply the processing gas 10 into the supply chamber 24. Supplying the processing gas 10 directly at the nozzle body 22 in this manner is typically necessary in the mirror cutting head 4b shown in FIG. 2b because, as discussed above, in a mirror cutting head the pressure increase occurs at the laser processing nozzle 17b.

FIG. 5 shows an improved construction of a laser processing nozzle 17c, in which a rounded portion 28c is adjoined between the first and second conical portions 28a, 28b in order to obtain a continuous transition between the two conical portions 28a, 28b and therefore to prevent turbulence. A cylindrical portion 28d, which has a length of approximately 0.5 mm in the direction of the nozzle longitudinal axis 23 and on which the discharge opening 30 is formed, adjoins the second conical portion 28b.

FIG. 6 shows a laser processing nozzle 17d in which the opening region 28 is substantially smooth and continuous, expanding in the form of a trumpet-shaped curve opening. In some cases, the opening angle α which is approximately 20° directly adjacent to the mouth region 25 increases continuously as the distance relative to the mouth region 25 increases. The opening region 28 can, in some cases be terminated by a cylindrical portion, as in FIG. 5, on which the discharge opening 30 is formed.

Generally, the laser processing nozzles 17a-d shown in FIGS. 3 to 6 have a first portion 28a of the opening region 28 having an opening angle α of more than 20°, that is to say, the opening region 28 is larger than the opening angle of a De Laval nozzle with a comparable mouth diameter d2.

While certain embodiments have been described, other embodiments are possible.

Although the step 26 in FIGS. 3 to 6 is illustrated to be positioned along a plane perpendicular to the nozzle axis 23, in some embodiments, the step 26 can be positioned along a plane non-perpendicular to the nozzle axis 23. For example, the step 26 can be positioned along a plane at an angle between 70° and 110° from the nozzle axis 23, as long as the step 26 produces turbulence in the processing gas 10.

Although the laser processing nozzle 17b shown in FIG. 4 has been the only laser processing nozzle described as having an annular gap 31 for use on the mirror cutting head 4b of FIG. 2b, other laser processing nozzles can have an annular gap 31. For example, the laser processing nozzles 17a, 17c, 17d of FIGS. 3, 5 and 6 can be provided with an annular gap 31 for use on the mirror cutting head 4b of FIG. 2b.

In the above-described cases, the laser processing nozzle 17a-d can be used for cutting high-grade steel sheets having a thickness of more than 8 mm in an operationally stable manner.

A number of embodiments of the invention have been described. Nevertheless, it will be understood that various modifications may be made without departing from the spirit and scope of the invention. Accordingly, other embodiments are within the scope of the following claims.

What is claimed is:

1. A laser processing nozzle for processing metal sheets, the laser processing nozzle comprising:
a supply chamber for a processing gas and a laser beam;
a mouth region which directly adjoins the supply chamber along a longitudinal axis of the nozzle, the mouth region being narrowed relative to the supply chamber and forming a minimum diameter of the laser processing nozzle; and
an opening region which adjoins the mouth region along the longitudinal axis of the nozzle and which widens relative to the mouth region,
wherein a step is formed between the supply chamber and the mouth region for swirling the processing gas.

2. The laser processing nozzle according to claim 1, wherein a cross-sectional area that the step covers is at least four times as large as a cross-sectional area of the mouth region.

3. The laser processing nozzle according to claim 1, wherein a first conical portion of the opening region directly adjoining the mouth region has a first opening angle which is between 20° and 80°.

4. The laser processing nozzle according to claim 3, wherein the first opening angle is between 25° and 35°.

5. The laser processing nozzle according to claim 3, wherein
a second conical portion of the opening region adjoining the first portion has a second opening angle which is between 100° and 160°.

6. The laser processing nozzle according to claim 5, wherein the second opening angle is between 135° and 145°.

7. The laser processing nozzle according to claim 5, wherein a rounded portion is formed between the first portion and the second portion.

8. The laser processing nozzle according to claim 1, wherein an opening angle of the opening region increases continuously as the distance from the mouth region increases.

9. The laser processing nozzle according to claim 1, wherein a diameter of the discharge opening of the laser processing nozzle formed at the opening region is at least twice as large as a length of the opening region along the longitudinal axis of the nozzle.

10. The laser processing nozzle according to claim 1, wherein the supply chamber and the mouth region are arranged coaxially relative to the longitudinal axis of the nozzle.

11. The laser processing nozzle according to claim 10, wherein the supply chamber and the mouth region are cylindrical.

12. A laser processing machine comprising:
a workpiece support;
a laser resonator;
a laser processing head; and
a laser processing nozzle connected to the laser processing head, the laser processing nozzle comprising
a supply chamber for a processing gas and a laser beam,
a mouth region which directly adjoins the supply chamber along a longitudinal axis of the nozzle, the mouth region being narrowed relative to the supply chamber and forming a minimum diameter of the laser processing nozzle, and
an opening region which adjoins the mouth region along the longitudinal axis of the nozzle and which widens relative to the mouth region,
wherein a step is formed between the supply chamber and the mouth region for swirling the processing gas, and wherein the laser processing machine is configured to cut steel sheets having a thickness greater than 8 mm.

13. The laser processing machine according to claim 12, wherein a cross-sectional area that the step covers is at least four times as large as a cross-sectional area of the mouth region.

14. The laser processing machine according to claim 12, wherein a first conical portion of the opening region directly adjoining the mouth region has a first opening angle which is between 20° and 80°.

15. The laser processing machine according to claim 14, wherein
a second conical portion of the opening region adjoining the first portion has a second opening angle which is between 100° and 160°.

16. The laser processing machine according to claim 12, wherein a diameter of the discharge opening of the laser processing nozzle formed at the opening region is at least twice as large as a length of the opening region along the longitudinal axis of the nozzle.

17. A method comprising:
delivering a processing laser through a laser processing nozzle to a steel sheet workpiece having a thickness greater than 8 mm to form a molten portion in the workpiece; and
delivering gas through the laser processing nozzle such that turbulent flow of the gas is generated to provide a pressure cushion between the laser processing nozzle and the steel sheet workpiece to discharge the molten portion from the steel sheet workpiece,
wherein the turbulent flow of the gas is generated by a step formed between a supply chamber of the laser processing nozzle and a mouth region of the laser processing nozzle.

18. The method according to claim 17, wherein the pressure cushion is provided to the steel sheet workpiece through an opening region of the laser processing nozzle which adjoins the mouth region of the laser processing nozzle along the longitudinal axis of the laser processing nozzle, and the opening region of the laser processing nozzle widens relative to the mouth region of the laser processing nozzle.

19. The method according to claim 18, wherein a first conical portion of the opening region directly adjoining the mouth region has a first opening angle which is between 20° and 80°.

20. The method according to claim 19, wherein a second conical portion of the opening region adjoining the first portion has a second opening angle which is between 100° and 160°.

21. The method according to claim 17, wherein a cross-sectional area that the step covers is at least four times as large as a cross-sectional area of the mouth region of the laser processing nozzle.
